(19) United States
(12) Patent Application Publication
(10) Pub. No.: US 2010/0227232 A1
(43) Pub. Date: Sep. 9, 2010

(54) Initiating a Reaction Between Hydrogen Peroxide and an Organic Compound

(76) Inventor: Tiancun Xiao, Oxford (GB)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/989,905

(22) PCT Filed: Jul. 28, 2006
(86) PCT No.: PCT/GB2006/002822

§ 371 Date: May 14, 2010

(30) Foreign Application Priority Data
Aug. 2, 2005 (GB) 0515916.5
Aug. 18, 2005 (GB) 0516993.3

(51) Int. Cl. H01M 8/06

(52) U.S. Cl. 429/420; 429/423

(57) ABSTRACT

A process for initiating a reaction between hydrogen peroxide and an organic compound which comprises contacting the hydrogen peroxide and the organic compound in the liquid phase in the presence of a catalyst; wherein:
a) the organic compound is an alcohol, carbohydrate, aldehyde, ketone, carboxylic acid or ether;
b) the catalyst comprises at least one group 7, 8, 9, 10 or 11 transition metal;
c) the ratio of H₂O₂:atomic carbon in the organic compound is from 0.2:1 to 6:1; and
d) the ratio of any water present:atomic carbon in the organic compound is from 0:1 to 2:1;
   with the proviso that the organic compound is not or does not comprise methanol.

The present invention relates to a process involving a reaction between an organic compound and hydrogen peroxide to produce a gas, such as a hot gas mixture, in particular a process which uses a catalyst. And which is able to start spontaneously when the reactants contact the catalyst, preferably even at room temperature.

Hydrocarbon reforming to produce hydrogen or other gases is well known in the art. These reactions often happen through steam reforming, dry reforming or partial oxidation. To initialise the reaction, the reactants need to be heated to at least 200° C. for methanol, or at least 400° C. for ethanol. Partial oxidation using oxygen is an exothermic reaction, but it needs to initialise at 200° C. or above so after the reaction has started it will continue without additional heat input.

Unpublished application no. PCT/GB 2005/000401 discloses the initiation of a reaction between methanol and a peroxide using a catalyst comprising a group 7, 8, 9, 10 or 11 transition metal.

In the published prior art, in order to initiate the reaction between an organic compound and hydrogen peroxide in the gas phase over a solid catalyst, the reactants are heated to 230° C. The reaction may be exothermic, so after the reaction has started it may continue with little or no additional heat input. However, hydrogen peroxide may decompose into steam or liquid water and oxygen at such high temperatures before it reacts with the organic compound. It would be desirable to initiate the reaction without heating the reactants to such a high temperature, especially to initiate the reaction at a temperature below the boiling point of the reactants such that the reaction is able to occur in the liquid phase. Direct heating is inefficient and, in some instances, unavailable, for example when reacting the reactants to produce hydrogen in a moving vehicle or portable electrical appliance. Furthermore heating hydrogen peroxide to such a high temperature can be dangerous since it is explosive.

We have now discovered a process in which organic compounds such as an alcohol having a longer carbon chain than methanol or a carboxylic acid can be directly reacted with hydrogen peroxide together without initially having to heat them to a high temperature. This process utilises a particular catalyst and particular initiation conditions.

Accordingly the present invention provides a process for initiating a reaction between hydrogen peroxide and an organic compound which comprises contacting the hydrogen peroxide and the organic compound in the liquid phase in the presence of a catalyst; wherein:
a) the organic compound is an alcohol, carbohydrate, aldehyde, ketone, carboxylic acid or ether;
b) the catalyst comprises at least one group 7, 8, 9, or 11 transition metal;
c) the ratio of H₂O₂:atomic carbon in the organic compound is from 0.2:1 to 6:1, preferably 0.5:1 to 6:1; and
d) the ratio of any water present:atomic carbon in the organic compound is from 0:1 to 2:1;
   with the proviso that the organic compound is not or does not comprise methanol.

When referring to groups of the periodic table of elements, the IUPAC convention has been used. Group 7, 8, 9, 10 and 11 transition metals are also known as Group VIIB, VIII and IB transition metals.

The pressure at which the initiation is carried out may be equal to, below or above atmospheric pressure. Preferably the pressure is equal to or above atmospheric pressure.

In the process of the present invention the reaction between the organic compound and hydrogen peroxide is initiated by contacting the reactants in the liquid phase in the presence of a particular catalyst. The reaction occurs in the same reaction medium. Thus, the organic compound and hydrogen peroxide reactants come into contact with one another in the same medium and not across a membrane, such as a fuel cell membrane.

It has surprisingly been found that little if any heat has to be provided to the system in order to initiate the reaction. After the reaction is initiated the organic compound and peroxide may continue to react if the reaction is exothermic. Although the catalyst need not remain in the reaction system after the reaction has been initiated if the reaction is able to continue without the catalyst, in practice it is usual for the catalyst to remain in place rather than being removed.

The organic compound is an alcohol, carbohydrate, aldehyde, ketone, carboxylic acid or ether or a mixture of two or more thereof. The organic compound is desirably soluble in the reaction medium at the time of initiation if it is a solid. The alcohol may, for example, be a C₂ to C₁₂ alcohol, for example a C₂ to C₆ alcohol. It may contain 1, 2, 3 or more hydroxyl groups. Examples of suitable alcohols are ethanol, isopropanol, n-propanol, butanol and diols and triols such as glycol and glycerol. The aldehyde may, for example, be a C₁ to C₁₂ aldehyde, for example a C₁ to C₄ aldehyde.

Examples of suitable aldehydes are formaldehyde, acetic aldehyde and propanol. The ketone may, for example, be a C₃ to C₁₂ ketone, for example a C₃ to C₆ ketone. An example of a suitable ketone is acetone. The carboxylic acid may be, for example, a C₁ or C₂ to C₁₂ carboxylic acid, for example a C₁ or C₂ to C₆ carboxylic acid. Examples of suitable carboxylic acids are formic acid and acetic acid. The ether may be, for example, a C₂ to C₁₂ ether, for example a C₂ to C₆ ether. Examples of suitable ethers are dimethyl ether, methyl ethyl ether, diethyl ether and CH₃—O—C₂H₄—O—CH₃.

The carbohydrate may, for example, be a sugar, starch, cellulose or gum. Example of suitable sugars are glucose, sucrose, fructose and maltose. Examples of suitable starches are soluble starch and starch from a vegetable origin such as potato starch or flours such as grain flour. Examples of cellulose are modified cellulose such as hydroxymethyl cellulose and hydroxyethyl cellulose. Examples of gums are gums of a natural origin such as xanthan gum or guar gum. When using these natural products, they may be pre-heated to a temperature to start the reaction. The reaction can be sustained without further heat input.

If a flour or non-soluble starch is used, it is usually mixed with the H₂O₂ solution and heated to over 50° C. to form a gel.

The organic compound can be used by itself or in admixture with other components such as, for example, other alcohols or hydrocarbons, for example C₂ to C₆ alcohols, such as ethanol, propanol and butanol, gasoline, alkanes such as pentane and hexane, diesel or water. Since the reaction is exothermic, once the reaction between the organic compound and the hydrogen peroxide has been initiated, heat is generated which can itself cause a reaction to initiate between additional components such as between ethanol, gasoline and/or diesel and the hydrogen peroxide or between the organic compound and water.

The reaction between the alcohol and the hydrogen peroxide can vary, for example depending upon the stoichiometric amounts of the reactants which are present. For example the reaction may comprise at least one of:

CH₃CH₂OH+H₂O₂+H₂O→5H₂+2CO₂

CH₃CH₂OH+3H₂O₂→2CO₂+3H₂O+3H₂

CH₃CH₂OH+2H₂O₂→2CO₂+H₂O+4H₂

CH₃CH₂OH+H₂O₂→H₂O+2CO+3H₂

The mole ratio of H₂O₂ to ethanol should be at least 0.2:1, especially 0.25:1.

The reactions between the carboxylic acid and the hydrogen peroxide may comprise at least one of:

2CH₃COOH+H₂O₂→2CO₂+2H₂O+H₂

3CH₃COOH+H₂O₂→3CO₂+2H₂O+2H₂

4CH₃COOH+H₂O₂→4CO₂+2H₂O+3H₂

CH₃COOH+H₂O₂→CO₂+2H₂+H₂O+CO

2CH₃COOH+H₂O₂→2CO₂+4H₂+2CO

CH₃COOH+2H₂O₂→CO₂+H₂+3H₂O+CO

HCOOH+H₂O₂→2H₂O+CO₂

HCOOH+0.5H₂O₂→1.5H₂O+CO₂+0.5H₂

CH₃COOH+4H₂O₂→2CO₂+6H₂O

The ratio of H₂O₂:atomic carbon is from 0.2:1 to 6:1, preferably 0.5:1 to 6:1, more preferably 0.5:1 to 4:1.

The reactions between ethers and hydrogen peroxide may comprise at least one of:

CH₃OCH₃+H₂O₂→2CO+3H₂+H₂O

CH₃OCH₃+H₂O₂→CO+4H₂+CO₂

CH₃OCH₃+2H₂O₂→CO+3H₂+H₂O+CO₂

CH₃OCH₃+3H₂O₂→3H₂+2H₂O+2CO₂

CH₃OCH₃+4H₂O₂→2H₂+4H₂O+2CO₂

The reaction between aldehyde and hydrogen peroxide may comprise at least one of:

2CH₂O+H₂O₂→CO+CO₂+H₂O+2H₂

2CH₂O+H₂O₂→2CO₂+3H₂

CH₂O+H₂O₂→CO₂+H₂O+H₂

CH₃CHO+H₂O₂→CO₂+CO+3H₂

CH₃CHO+2H₂O₂→2CO₂+H₂O+3H₂

CH₃CHO+2H₂O₂→CO₂+CO+2H₂O+2H₂

CH₃CHO+3H₂O₂→2CO₂+3H₂O+2H₂

CH₃CHO+4H₂O₂→2CO₂+5H₂O+H₂

CH₃CHO+5H₂O₂→2CO₂+7H₂O

The reaction between glucose and hydrogen residue may comprise at least one of:

C₆H₁₂O₆+12H₂O₂→18H₂O+6CO₂

C₆H₁₂O₆→11H₂O₂→—H₂+16H₂O+6CO₂→17H₂O+CO+5CO₂

C₆H₁₂O₆+10H₂O₂→2H₂+14H₂O+6CO₂→15H₂O+CO++H₂+5CO₂

C₆H₁₂O₆+9H₂O₂→3H₂+12H₂O+6CO₂→13H₂O+CO+2H₂+5CO₂

C₆H₁₂O₆+81H₂O₂→4H₂+10H₂O+6CO₂→11H₂O+CO+3H₂+5CO₂

C₆H₁₂O₆+71H₂O₂→5H₂+8H₂O+6CO₂→9H₂O+CO+4H₂+5CO₂

C₆H₁₂O₆+61H₂O₂→6H₂+6H₂O+6CO₂→7H₂O+CO+5H₂+5CO₂

C₆H₁₂O₆+51H₂O₂→7H₂+4H₂O+6CO₂→5H₂O+CO+65H₂+5CO₂

C₆H₁₂O₆+41H₂O₂→8H₂+2H₂O+6CO₂→3H₂O+CO+7H₂+5CO₂

C₆H₁₂O₆+31H₂O₂→9H₂+6H₂O+6CO₂→H₂O+CO+8H₂+5CO₂

In one embodiment, the heat generated by the reaction between the organic compound and the hydrogen peroxide is used to drive a reforming reaction. The reaction between the organic compound and hydrogen peroxide may be used to provide some or all of the heat necessary for the reforming reaction, allowing the reforming reaction to be carried out with little or no additional heating. In one embodiment, at least 50%, preferably, at least 80%, more preferably, at least 95%, yet more preferably 100%, of the heat necessary to drive the reforming reaction is provided by the reaction between the organic compound and hydrogen peroxide.

The water required for the reforming step may be added to the reaction or may be produced in situ, for example, as a result of the reaction between the organic compound and peroxide.

The reforming reaction may be a direct reforming reaction between the organic compound and hydrogen peroxide and/or water. Alternatively or additionally, one or more other organic compounds may be reformed in the reforming step. Examples of compounds that may be reformed include alcohols and hydrocarbons. Suitable alcohols include C₁ or C₂ to C₈ alcohols, preferably, C₁ to C₄ or C₂ to C₄ alcohols, such as ethanol, propanol and butanol. Suitable hydrocarbons include alkanes, such as C₁ to C₃₀ alkanes, for example, C₁ to C₂₅ alkanes. Examples of suitable alkanes include methane, ethane, propane, butane, pentane, hexane, heptane, octane and mixtures thereof. Gasoline and/or diesel may also be reformed. Reforming can take place to form hydrogen and carbon dioxide, optionally together with carbon monoxide. Methane may also be present in the product stream, for example, as a by-product.

If desired, any carbon monoxide produced in the reforming reaction may be reacted with water and converted to carbon dioxide and hydrogen in a water gas shift reaction. The reforming reaction, therefore, may optionally be carried out as a precursor to a water gas shift reaction. The water required for this water gas shift reaction may be added to the products of the reforming step, or may be residual water from the reforming step or the reaction between the organic compound and the hydrogen peroxide.

The water gas shift reaction may be carried out under any suitable reaction conditions and using any water gas shift suitable catalyst(s). For example, temperatures of 150 to 600° C., preferably 200 to 500° C., for example 200 to 250° C. or 300 to 450° C. may be employed. Suitable water gas shift catalysts include catalysts based on copper and/or zinc, optionally supported on a support. Examples include Cu/Zn/Al₂O₃ and CuO/Mn/ZnO. The heat necessary for the water gas shift reaction may be provided at least in part by the exothermic reaction between the organic compound and the hydrogen peroxide.

Any residue CO remaining after the water gas shift reaction can be removed, for example by membrane separation, preferential oxidation or methanation. For the preferential oxidations, the oxygen can be provided, for example, by gaseous oxygen or H₂O₂ vapour.

According to a further aspect of the invention, there is provided an apparatus for carrying out a reforming reaction, said apparatus comprising:
storage means containing hydrogen peroxide and an organic compound which is an alcohol, carbohydrate, aldehyde, ketone, carboxylic acid or ether with the proviso that the organic compound is not or does not comprise methanol;
a housing containing at least one group 7, 8, 9, 10 or 11 transition metal catalyst, preferably a platinum-containing catalyst; and
means for introducing the hydrogen peroxide and organic compound into the housing.

The organic compound and hydrogen peroxide are preferably stored in separate storage means but may be stored together.

In use, the organic compound and hydrogen peroxide are transferred from the storage means into the housing and brought into contact with the catalyst. The reaction between the organic compound and peroxide is initiated by contacting the reactants in the liquid phase with the catalyst. As explained above, little or no heat has to be provided to the system in order to initiate the reaction. After the reaction is initiated the organic compound and peroxide continue to react since the reaction is exothermic.

The heat generated by the reaction between the organic compound and hydrogen peroxide is used at least in part to drive a reforming reaction. For example, at least 50%, preferably, at least 80%, more preferably, at least 95%, yet more preferably 100%, of the heat necessary to drive the reforming reaction is provided by the reaction between the organic compound and peroxide. Thus, the apparatus of the present invention need not include additional means for heating the reforming reaction.

The reactant feeds introduced into the housing also need not be heated.

Water for the reforming reaction may be introduced into the housing and/or may be generated in situ, for example, as a result of the reaction between the organic compound and hydrogen peroxide.

In one embodiment, at least part of the organic compound is reformed. Alternatively or additionally, the heat generated by the reaction between the organic compound and hydrogen peroxide is used to reform at least one further organic compound, which is preferably introduced into the housing via an inlet. In one embodiment, the apparatus nay include storage means for the organic compound. Alternatively or additionally, organic compound may be stored with the organic compound used for the initiation.

The organic compound to be reformed may be an alcohol and/or a hydrocarbon. Examples of suitable alcohols and hydrocarbons are identified above.

As mentioned above, the reforming reaction may produce a product stream comprising hydrogen and carbon dioxide. The product stream, and in particular the hydrogen produced, may be withdrawn from the housing and used for any suitable purpose. In one embodiment, for example, the hydrogen produced in the reforming reaction may be used to operate a fuel cell. Accordingly, the apparatus of the present invention may be used in combination with a fuel cell.

The reforming reaction may also produce carbon monoxide and side products such as alkanes or olefins. Any carbon monoxide produced may be converted to carbon dioxide and hydrogen using a water gas shift reaction. Thus, the housing of the apparatus preferably contains a water gas shift catalyst located downstream of the catalyst comprising at least one group 7, 8, 9, 10 or 11 transition metal. Suitable water gas shift catalysts are described above. The product stream from the water gas shift reaction is typically richer in hydrogen than the product stream emerging from the reforming reaction. In one embodiment, this hydrogen-enriched product stream is used, directly or indirectly, to operate a fuel cell.

The catalyst comprising at least one group 7, 8, 9, 10 or 11 transition metal and/or the water gas shift Catalyst may be provided in the form of a removable insert that may be removed from the housing and replaced when required.

The hydrogen peroxide employed in the process and apparatus of the present invention may be in any suitable form. It may be used, if desired, together with an organic peroxide.

The hydrogen peroxide can be used in pure form, but is preferably used in solution, especially in aqueous solution or alcohol solution. It may also be in the form of pellets, such as urea pellets. Generally the hydrogen peroxide is used in an aqueous solution, alcohol solution or pellets comprising at least 6 vol % hydrogen peroxide, preferably 8 vol % hydrogen peroxide, more preferably at least 10 vol %, even more preferably 15 vol %, yet more preferably 20 to 90 vol %, for example 20 to 80 vol %, and most preferably 25 to 60 vol %.

We have found however, that the amount of water present in the reaction mixture at the time of initiation must be strictly controlled. The ratio of water present (measured as H₂O molecules) to atomic carbon in the organic compound (measured as number of molecules of organic compound multiplied by the number of carbon atoms in each molecule) must be from 0:1 to 2:1, preferably up to 1.5:1, more preferably up to 1:1 and even more preferably up to 0.5:1. The amount of water may be controlled, for example, by ensuring that the hydrogen peroxide is not used in the form of an aqueous solution. If it is in the form of an aqueous solution, it is preferably in the form of a concentrated solution, for example comprising at least 30 vol %, preferably at least 51 vol % and most preferably at least 70 vol % hydrogen peroxide by volume.

The hydrogen peroxide and organic compound are present in a ratio of 0.2:1 to 6:1, preferably 0.5:1 to 6:1 measured as hydrogen peroxide to atomic carbon in the organic compound (as defined above). Preferably the ratio is 0.5:1 to 4:1, more preferably 1:1 to 4:1, even more preferably 1:1 to 3:1 and most preferably 1:1 to 2:1.

An additional solvent may be present if desired such as, for example, water or an organic solvent. The water is preferably used in the liquid phase. The reactants are contacted in the liquid phase, that is both the organic compound and the hydrogen peroxide are in the liquid phase. Of course, during the subsequent reaction, due to the presence of heat one or more than one of the reactants may be at least partly in the gaseous phase. An additional gas may be present if desired such as, for example, an oxygen-containing gas, such as air. Thus, the reaction between the organic compound and the hydrogen peroxide may be a reaction between the organic compound, the hydrogen peroxide and oxygen.

The reforming reaction may produce a product stream comprising superheated steam and CO₂, with trace amounts of H₂, O2, CH₄ and/or CO. This gas mixture can be mixed with water to produce suitable steam or can be used to drive mechanical tools, machinery or vehicles, or for a steam turbine or electricity generator.

The catalyst comprises a group 7, 8, 9, 10 or 11 transition metal. Thus the catalyst comprises one or more of Fe, Co, Ni, Cu, Tc, Ru, Rh, Pd, Ag, Re, Os, Ir, Pt and Au. Preferably, the metal is selected from groups 8, 9, 10 and/or 11 of the periodic table. Suitable group 8, 9, 10 or 11 metals include Ni, Co, Cu, Ag, Ir, Au, Pd, Ru, Rh and Pt. The metal is preferably platinum. Combinations of two or more metals may be present in the catalyst.

The catalyst is preferably promoted, for example with one or more oxides of alkali metal, alkaline earth metal, rare earth or other transition metals. Examples of suitable promoters are Sn, Ni, Ag, Zn, Au, Pd, Mn and other transition metals in the form of the metal, oxide or a salt. The catalyst may also be modified with one or more further components, such as boron, phosphorus, silica, selenium or tellurium.

The metal may be used in metallic form or in alloy form. In order to act effectively as a catalyst it is desirably in particulate form with a small particle size, as is well known to those skilled in the art. The catalyst may be unsupported. Desirably, however, it is supported. In an embodiment, for example, the catalyst is supported on the side of a reaction vessel or tube or on an inert particulate support. For example, very fine nickel or platinum particles may be plated in an inner layer on a stainless steel tube for methanation in a GC for FID detection.

The support may be any support which is capable of bearing the catalyst in the desired reaction. Such supports are well known in the art. The support may be an inert support, or it may be an active support. Examples of suitable supports include carbon supports and/or solid oxides, such as alumina, modified alumina, spinel oxides, silica, modified silica, magnesia, titania, zirconia, a zeolite, β-aluminate and manganese oxide, lanthanum oxide or a combination thereof. The alumina or modified alumina may be, for example, α-alumina, β-alumina or γ-alumina. β-alumina and spinel oxides such as barium hexaaluminate have been found to be particularly useful in view of their stability. The carbon may be in the form, for example, of active carbon, graphite or carbon nanotubes. A molecular sieve, such as a zeolite, may be chosen depending on the desired final product. Thus, for example, it may comprise pores or channels. Phosphide, boride, sulphide and/or metal supports may also be suitable.

Preferably the support is porous. The particle size is desirably 0.1 μm to 10 mm, more preferably 0.2 μm to 0.4 mm. The surface area is desirably greater than 1 m²/g, preferably greater than 5 m²/g. One or a mixture of two or more supports may be used.

The metal employed as the catalyst may also be in the form of a complex or compound thereof. Examples are platinum carbonyl complexes, ammonium platinum nitrate and platinum methoxy complexes, and platinum complexes with ligands such as chlorine, phosphine or organic aromatic species such as benzene or cyclopentadiene, such as (CO)₅CO₂(CO)₂Pt₂(CO)(PPh₃)₂ or Pt₃(CO)₂(PPh₃)₄.

Preferably the catalyst is a supported catalyst, especially a platinum-containing catalyst, promoted with at least one oxide of an alkali metal, alkaline earth metal, rare earth or other transition metal.

Before use, the catalyst may, if desired, be activated, for example with hydrogen or a hydrogen-containing gas.

Methods by which supported metal catalysts may be prepared are described, for example, in Catalysis Today, 1999, 51, 535, Catalysis Today, 2003, 77, 229, DE-A-19 841 227, DE-A-3,340,569 and DE-A-3,516,580. Suitable methods are, for example, impregnation, ion-exchange or sol-gel methods. For example a support, such as zirconia, alumina or silica, is dried and then impregnated or mixed with a solution of a group 7, 8, 9, 10 or 11 transition metal salt such as a nitrate, e.g. (NH₄)₂Pt (NO₃)₄, Pd (NO₃)₂, Cu (NO₃)₂, CO(NO₃)₂ or Ru(NO)(NO₃)₂, dried and calcined, for example at a temperature of about 400° C., to obtain a catalyst precursor. The catalyst precursor is then reduced, for example in flowing hydrogen, for example at 200° C. or above. A chloride salt may also be used, but residue chloride must be completely removed before use as a catalyst.

The initiation can desirably be carried out at about room temperature, for example at about 20° C. Preferably the initiation is carried out without heating the reactants or providing any other source of initiation. However, heat can be supplied if necessary, for example to promote the reaction between peroxide and natural soluble products such as sugar, starch or wheat or rice flour, although the amount of heat supplied need not be too great. Thus one or both of the reactants, or the reaction mixture, be at, for example, less than 700° C., preferably less than 100° C. and more preferably less than 80° C., more preferably less than 50° C. and even more preferably less than 30° C.

The reaction may also take place in the presence of other catalysts. For example, in a reforming reaction, a water gas shift and preferential oxidation catalyst to reduce the CO content to less than 10 ppm may be used. In such a case the H₂O₂:organic compound ratio is generally less than 3.

The reaction between the organic compound and the hydrogen peroxide has a number of uses. For instance, when propulsion is needed (e.g. for a rocket or for steering a satellite), the reaction between the organic compound and hydrogen peroxide can be used. The reaction may also be used to generate heat, for example, for the start-up of an autocatalyst or to power an engine.

When hydrogen is produced it may be important to restrict the amount of atmospheric oxygen which is available, for example by carrying out the reaction in an enclosed or pressure vessel.

When hydrogen is prepared the hydrogen may itself be used in a further process, for example in a fuel cell. Desirably he process of the present invention is carried out in or in association with a fuel cell in order to provide the hydrogen for a subsequent reaction or can be used to provide a rapid generation of gas and/or heat, for example for use in inflating an air bag, to pressurise mechanical equipment such as a hydraulic or lift, or for the quick start up of a catalystic exhausted gas converter or NOₓ purifier, or for driving a motor, to generate electricity, or for disinfection or decontamination.

### EXAMPLES

The present invention is now further described in the following Examples.

The catalysts preparation details are as follows.

The supports, e.g. ZrO2 (Saint Gobain Norpro), gamma-Al₂O₃ (Akzo-Nobel), Silica (Aldrich), MCM-41 (self-prepared using hydrothermal method), alpha alumina (Synetix) are first dried at 100° C., then impregnated with equivalent volume of 1M NaOH solution, dried at 100° C. for 2 hours, and calcined at 600° C. for 4 hours to obtain modified supports. These are then impregnated with a solution or mixed solution of (NH₄)₂Pt(NO₃)₄, Pd(NO₃)₂, Cu(NO₃)₂, or Ru(NO)(NO₃)₂ under ambient conditions, dried at 100° C., and then calcined at 400° C. to obtain catalysts precursors. Before the catalyst is used for reforming reaction, the catalyst precursor is reduced with flowing hydrogen at 200° C. or above for 1 hour.

In the reforming reaction, the catalysts are loaded above a catalyst layer of a water gas shift catalyst to reduce CO concentration. The catalysts are first reduced using flowing hydrogen (8 ml/min) at a rate of 2° C./rain to 300° C., and held for 1 hour, and then cooled to room temperature in flowing hydrogen.

The pre-mix of the organic compound mentioned in the following Examples and hydrogen peroxide water solution is stored in a glass flask and then pumped at a rate of 0.2 ml/min liquid to a 9 mm (o.d.) quartz reactor containing a layer of 0.1 g of the reforming catalyst prepared as indicated above and a lower layer of water gas shift catalyst (CuZnAlOₓ (0.2 g). When the liquid contacts the catalyst, gas is spontaneously produced.

### Example 1

A formic acid and hydrogen peroxide mixture is pumped to 0.1 g 2 wt % Pt/Na₂O/ZrO₂, CHOOH/H₂O₂/H₂O=1:0.6:0.4; flowing rate: 0.2 ml/min. starting at room temperature. Hydrogen gas is produced instantly, and the temperature of the catalyst bed is increased to 150° C. to 250° C. and maintained in this range without external heating.

Analysis of the products shows water, hydrogen, carbon dioxide and carbon monoxide, as the products. The hydrogen yield is over 99.8%. The formic acid conversion is 100%.

### Example 2

Acetic acid and hydrogen peroxide mixture is pumped to 0.1 g 2 wt % Pt/ZrO₂, CH₃COOH/H₂O₂/H₂O=1:2:0.8; flowing rate: 0.2 ml/min. starting at room temperature. Hydrogen gas is produced instantly, and the temperature of the catalyst bed is increased to 250° C. to 300° C. and maintained in this range without external heating.

Analysis of the products shows water, hydrogen, carbon monoxide, methane and carbon dioxide as the products. The hydrogen yield is over 99.5%. Some CO₂ is adsorbed by the NaOH solution condenser.

### Example 3

An ethanol and hydrogen peroxide mixture is pumped to 0.1 g 2 wt % Pt/ZrO₂, CH₃COOH/H₂O₂/H₂O=1:2:0.8; flowing rate: 0.2 ml/min. starting at room temperature. Hydrogen gas is produced instantly. The temperature at steady state is about 600° C. and maintained at about this temperature without external heating.

The main products are hydrogen and carbon dioxide. The hydrogen yield is 95%. There is a trace of olefin and methane produced.

### Example 4

An ethanol and hydrogen peroxide mixture is pumped to 0.1 g 1 wt % Pt/Al₂O₃, CH₃CH₂OH/H₂O₂/H₂O=1:2.5:1.1; flowing rate: 0.2 ml/min. starting at room temperature. Hydrogen gas is produced instantly, the temperature at steady state is about 580° C. and maintained at about this temperature without external heating.

The main products are hydrogen and carbon dioxide. The hydrogen yield is 94%. There is a trace of olefin and methane produced.

### Example 5

An ethanol and hydrogen peroxide mixture is pumped to 0.1 g 0.9 wt % Pt0.2Pd/0.5NaO/ZrO₂, CH₃CH₂OH/H₂O₂/H₂O=1:3:1.2; flowing rate: 0.2 ml/min. starting at room temperature. Hydrogen gas is produced instantly, the temperature at steady state is about 520° C. and maintained at about this temperature without external heating.

The main products are hydrogen and carbon dioxide. The hydrogen yield is 92% and ethanol conversion is 96%. There is a trace of olefin and methane produced.

### Example 6

An aldehyde and hydrogen peroxide mixture is pumped to 0.1 g 0.9 wt % Pt/5.6CuO/ZrO₂, CH₃CHO/H₂O₂/H₂O=1:2.6:1.2; flowing rate: 0.15 ml/min, starting at room temperature. Hydrogen gas is produced instantly. The temperature at steady state is about 600° C. and maintained at about this temperature without external heating.

The main products are hydrogen and carbon dioxide. The hydrogen yield is 92%, and the aldehyde conversion is 93%. There is a trace of olefin and methane produced.

### Example 7

An ethanol and hydrogen peroxide mixture is pumped to 0.1 g 1 . 5 wt % Pt/2 5Na₂O/ZrO₂, CH₃CHO/CH₃COOH/H₂O₂/H₂O=1:0.5:2:1; flowing rate: 0.2 ml/min. starting at room temperature. Hydrogen gas is produced instantly. The temperature at steady state is about 540° C. and maintained at about this temperature without external heating.

The main products are hydrogen and carbon dioxide. The hydrogen yield is 90% and ethanol conversion is 91%. There is a trace of olefin and methane produced.

### Example 8

A methyl ethyl ether and hydrogen peroxide mixture is pumped to 0.09 g 2 wt % Pt/alpha-Al₂O₃, CH₃CH₂OCH₃/H₂O₂/H₂O=1:3:1.2; flowing rate: 0.2 ml/min. starting at room temperature. Hydrogen gas is produced instantly. The temperature at steady state is about 540° C. and maintained at about this temperature without external heating.

The main products are hydrogen and carbon dioxide. The hydrogen yield is 85% and methyl ethyl ether conversion is 90%. There is a trace of olefin and methane produced.

### Example 9

An ethanol and octane mixture (equivalent to gasoline) and hydrogen peroxide is pumped over 0.1 g 3 wt % Pt/K₂O modified ZrO₂, CH₃CH₂OH/Octane/H₂O₂/H₂O=1:0.07:1.8; flowing rate: 0.3 ml/min. starting at room temperature. Hydrogen gas is produced instantly. The temperature at steady state is about 900° C. and maintained at about this temperature without external heating.

The main products are hydrogen and carbon dioxide. The hydrogen yield is 85% and ethanol conversion is 99.5%. The octane conversion is 98%. There is a trace of olefin and methane produced.

### Example 10

Ethanol, acetone, and cetane (equivalent to diesel) and hydrogen peroxide are pumped over 0.1 g 2 wt % Pt/2.5 wt % Na₂O modified gama Al₂O₃ CH₃CH₂OH/Acetone/cetane/H₂O₂/H₂O=1:0.2:0.05:4.6:2.1; flowing rate: 0.3 ml/min. starting at room temperature. Hydrogen gas is produced instantly. The temperature at steady state. is about 820° C. and maintained at about this temperature range without external heating.

The main products are hydrogen and carbon dioxide. The hydrogen yield is 95.5% and ethanol conversion is 99.5%. The cetane conversion is 97.8%. There is a trace of olefin and methane produced.

### Example 12

An ethanol, acetic acid and hydrogen peroxide mixture is pumped over 1.2 wt % Pt0.4 wtRu/SiO₂ starting at room temperature. CH₃CH₂OH/CH₃COOH/H₂O₂/H₂O=1:0.4:3.5:1.2. starting at room temperature. Hydrogen gas is produced instantly. The temperature at steady state is about 550° C. and maintained at about this temperature without external heating.

The main products are hydrogen and carbon dioxide. The hydrogen yield is 97% and ethanol conversion is 94%. The acetic acid conversion is 99.5%.

In the following examples 13 to 15 the catalyst and samples prepared as follows:

The dried supports, 1 g each of gamma-alumina and ZrO2 are dipped with 1 ml of 2&Pt aqueous solution (Pt from (NH₄)₂Pt(NO₃)₄), static placed for 2 hours, the excessive water vaporised, and then calcined at 500° C. for 2 hours. A supported PtO catalyst precursor is obtained. The PtO/Al₂O₃ and PtO/ZrO₂ were reduced in 15 ml/min flowing H₂ at 2° C./min to 400° C. Then 0.1 gram of the catalyst is loaded in a 9 mm (o.d) quartz tube plugged with silica wool.

A specific amount of glucose is dissolved in 70% H₂O₂/H₂O to obtain 25%, 30%, 50% sugar solutions in the 70% H₂O₂/H₂O. The sugar/OH₂O₂ solution is then pumped to the quartz tube loaded with the H₂-reduced catalyst at room temperature. The gas products was analysed using an Autosystem GC.

### Example 13

A glucose and hydrogen peroxide solution consisting of 25% glucose, 53% H₂O₂ and 12% water is pumped over 0.1 g 2Pt/gamma Al₂O₃ at a liquid flowing rate of 0.2 ml/min starting at room temperature. The temperature at steady rate is about 500° C. and maintained at about this temperature without external heating. The hydrogen yield is 85%, the carbon monoxide yield is 15% and the carbon dioxide yield is 85%.

### Example 14

A glucose and hydrogen peroxide solution consisting of 35% glucose, 46% H₂O₂ and 19% water is pumped over 0.1 g 2Pt/gamma Al₂O₃ at a liquid flowing rate of 0.2 ml/min starting at room temperature. The temperature at steady rate is about 450° C. and maintained at about this temperature without external heating. The hydrogen yield is 85%, the carbon monoxide yield is 20% and the carbon dioxide yield is 78%.

### Example 15

A glucose and hydrogen peroxide solution consisting of 30% glucose, 50% H₂O₂ and 20% water is pumped over 0.1 g 2Pt/gamma Al₂O₃ at a liquid flowing rate of 0.2 ml/min starting at room temperature. The temperature at steady rate is about 350° C. and maintained at about this temperature without external heating. The hydrogen yield is 60%, the carbon monoxide yield is 50% and some O₂ is produced.

### Example 16

0.2 g of Pt/Al₂O₃ (Pt from (NH₄)Pt(NO₃)₄, 4 wt %, particle size: 0.2 mm) is loaded in a 9 mm (O.D) quartz tube reactor. A mixture of H₂O₂ (38 wt %)/H₂O (30 wt %)/and soluble starch (32 wt %) is fed into the tube. Once the reactants contact the catalyst bed, the catalyst bed temperature rises to 150° C., and some gas is produced, which comprises H₂, CO and CO₂. After 2 hours reaction, the catalyst bed has some carbon deposition, and there is some oxygen present in the gas stream.

### Example 17

PtPd/Al₂O₃ catalyst (0.1 g, 2 wt % Pt, 3 wt % Pd) is loaded in a 9 mm quartz tube, and a mixture of H₂O₂ (43 wt %)/H₂O (15 wt %) and cooked wheat flour (42 wt %) is pumped into the catalyst at the rate of 0.15 ml/min. When the liquid contacts the catalyst, gas is produced, which is analysed as O₂. When heating the catalyst bed to 120° C., and the external heating source is removed, H₂ is produced at a rate of 60 ml/min.

### Example 18

50 mg of H₂ reduced 5 wt % Pd/Al₂O₃ (prepared by impregnating Pd(NO₃)₂ over alumina) was loaded in a 6 mm (0.D) quartz tube, and vertical erected. A liquid mixture of 56 wt % H₂O₂/24 wt % H₂O/20 wt % soluble starch is fed into the reaction and upflow to the catalyst bed. Once the liquid mixture contacts the catalyst bed, steam and CO₂ are produced, and the catalyst bed temperature increases to 850° C.

### Example 19

H₂O₂ 70 wt %/H₂O (30 gram) is mixed with 4 gram of wheat flour, stirring and heating to 100° C., to form a flowable slurry The slurry is then pumped to a catalyst bed containing 100 g of 2 wt % Pt/ZrO₂ loaded in a silica tube. When the liquid mixture contacts the tube, some oxygen is produced, while the temperature is only 60° C. When the catalyst bed is heated to 200° C., and then the external heating source is removed, the catalyst bed becomes red, and steam and CO₂ are the main products. The catalyst bed temperature reaches 700° C.

### Example 20

H₂O₂ 50%/H₂O (50g) is mixed with 4.6 g of sugar and forms a transparent solution. The solution is pumped to a catalyst bed containing 0.2 g 1 wt % Pd, 2 wt % Pt/ZrO₂ (reduced with H₂ at 500° C. for 2 hours). Once the liquid contacts the catalysts, the catalyst bed becomes red. The temperature reaches 568° C. and the main products are steam and CO₂.

### Example 21

A formic acid and hydrogen peroxide mixture is pumped to 0.1 g 2 wt %. Pt/Na₂O/ZrO₂, CHOOH/H₂O₂/H2O=1:1:2 (mol ratio); flowing rate=0.2 ml/min, starting at room temperature. A mixture of hot steam and CO₂ is produced instantly with a CO₂ concentration of up to 40 wt % in the gas stream and the temperature of the catalyst bed increases to 150° C. to 450° C. and is maintained in this range without external heating.

Analysis of the products shows water, hydrogen, carbon dioxide and carbon monoxide as the products. The hydrogen yield is over 99.8%. The formic acid convertion is 100%.

1. A process for initiating a reaction between hydrogen peroxide and an organic compound which comprises contacting the hydrogen peroxide and the organic compound in the liquid phase in the presence of a catalyst; wherein:
a) the organic compound is an alcohol, carbohydrate, aldehyde, ketone, carboxylic acid or ether;
b) the catalyst comprises at least one group 7, 8, 9, or 11 transition metal;
c) the ratio of H₂O₂:atomic carbon in the organic compound is from 0.2:1 to 6:1; and
d) the ratio of any water present:atomic carbon in the organic compound is from 0:1 to 2:1;
with the proviso that the organic compound is not or does not comprise methanol.

2. A process according to claim 1 wherein the metal is selected from one or more of nickel, cobalt, copper, silver, iridium, gold, palladium, ruthenium, rhodium and platinum.

3. A process according to claim 2 wherein the metal is platinum.

4. A process according to claim 1 wherein the metal is in metallic form.

5. A process according to claim 1 wherein the catalyst contains one or more catalyst precursors.

6. A process according to claim 1 wherein the hydrogen peroxide is in the form of an aqueous solution comprising at least 20 vol % hydrogen peroxide, preferably at least 30 wt % hydrogen peroxide, an alcohol solution or urea pellets comprising at least 6 vol % hydrogen peroxide.

7. A process according to claim 6 wherein the hydrogen peroxide is in the form of an aqueous solution comprising at least 51 vol % hydrogen peroxide.

8. A process according to claim 7 wherein the hydrogen peroxide is in the form of an aqueous solution comprising at least 70 wt % hydrogen peroxide.

9. A process according to claim 1 wherein the reaction between the peroxide and the organic compound produces at least one of hydrogen, carbon dioxide, carbon monoxide, ethane and oxygen.

10. A process according to claim 1 wherein the ratio of H₂O₂:atomic carbon in the organic compound is from 0.5:1 to 4:1, preferably 1:1 to 4:1.

11. A process according to claim 10 wherein the ratio of H₂O₂:atomic carbon in the organic compound is from 1:1 to 3:1.

12. A process according to claim 1 wherein the organic compound is an alcohol having from 2 to 6 carbon atoms or an aldehyde, ketone, carboxylic acid or ether having from 1 to 6 carbon atoms.

13. A process according to claim 12 wherein the organic compound is ethanol.

14. A process according to claim 1 wherein the organic compound is a sugar, starch, cellulose, flour or gum or a mixture thereof.

15. A process according to claim 14 wherein the sugar is glucose, sucrose, fructose or maltose.

16. A process according to claim 1 wherein the reaction comprises at least one of:
CH₃CH₂OH+H₂O₂+H₂O→5H₂+2CO₂
CH₃CH₂OH+3H₂O₂→2CO₂+3H₂O+3H₂
CH₃CH₂OH+2H₂O₂→2CO₂+2H₂O+3H₂O
CH₃CH₂OH+H₂O₂→H₂O+2CO+3H₂
HCOOH+H₂O₂→2H₂O+CO₂
HCOOH+0.5H₂O₂→0.5H₂+CO₂+1.5H₂O
2CH₃COOH+H₂O₂→2CO₂+2H₂O+H₂
3CH₃COOH+H₂O₂→3CO₂+2H₂O+2H₂
4CH₃COOH+H₂O₂→4CO₂+2H₂O+3H₂
CH₃COOH+H₂O₂→CO₂+2H₂+H₂O+CO
2CH₃COOH+H₂O₂→2CO₂+4H₂+2CO
CH₃COOH+2H₂O₂→CO₂+H₂+3H₂O+CO
CH₃COOH+4H₂O₂→2CO₂+6H₂O
CH₃OCH₃+H₂O₂→2CO+3H₂+H₂O
CH₃OCH₃+H₂O₂→CO+4H₂+CO₂
CH₃OCH₃+2H₂O₂→CO+3H₂+H₂O+CO₂
CH₃OCH₃+3H₂O₂→3H₂+2H₂O+2CO₂
CH₃OCH₃+4H₂O₂→2H₂+4H₂O+2CO₂
2CH₂O+H₂O₂→CO+CO₂+H₂O+2H₂
2CH₂O+H₂O₂→2CO₂+3H₂
CH₂O+H₂O₂→CO₂+H₂O+H₂
CH₃CHO+H₂O₂→CO₂+CO+3H₂
CH₃CHO+2H₂O₂→2CO₂+H₂O+3H₂
CH₃CHO+2H₂O₂—>CO₂+CO+2H₂O+2H₂
CH₃CHO+3H₂O₂→2CO₂+3H₂O+2H₂
CH₃CHO+4H₂O₂→2CO₂+5H₂O+H₂
CH₃CHO+5H₂O₂→2CO₂+7H₂O
C₆H₁₂O₆+12H₂O₂→18H₂O+6CO₂
C₆H₁₂O₆+11H₂O₂→H₂+16H₂O+6CO₂→17H₂O+CO+5CO₂
C₆H₁₂O₆+10H₂O₂→2H₂+14H₂O+6CO₂→15H₂O+CO++H₂+5CO₂
C₆H₁₂O₆+9H₂O₂→3H₂+12H₂O+6CO₂—→13H₂O+CO+2H₂+5CO₂
C₆H₁₂O₆+81H₂O₂→4H₂+10H₂O+6CO₂→11H₂O+CO+3H₂+5CO₂
C₆H₁₂O₆+71H₂O₂→5H₂+8H₂O+6CO₂→9H₂O+CO+4H₂+5CO₂
C₆H₁₂O₆+61H₂O₂→6H₂+6H₂O+6CO₂→7H₂O+CO+5H₂+5CO₂
C₆H₁₂O₆+51H₂O₂→7H₂+4H₂O+6CO₂→5H₂O+CO+65H₂+5CO₂
C₆H₁₂O₆+41H₂O₂→8H₂+2H₂O+6CO₂→3H₂O+CO+7H₂+5CO₂
C₆H₁₂O₆+31H₂O₂→9H₂+6H₂O+6CO₂→H₂O+CO+8H₂+5CO₂

17. A process according to claim 1 wherein the initiation is carried out at a temperature of less than 200° C., preferably less than 80° C.

18. A process according to claim 17 wherein the initiation is carried out at a temperature of less than 30° C.

19. A process according to claim 18 wherein the initiation is carried out at about or less than room temperature.

20. A process according to claim 1 wherein the initiation is carried out without heating the reactants.

21. A process according to claim 1 wherein the ratio of any water present:atomic carbon in the organic compound is from 0:1 to 1.5:1.

22. A process according to claim 21 wherein the ratio of any water present:atomic carbon in the organic compound is from 0:1 to 1:1.

23. A process according to claim 1 wherein the organic compound is ethanol, and the ratio of any water present:atomic carbon in the ethanol is from 0:1 to 1:1, preferably from 0:1 to 0.5:1.

24. A process according to claim 1 wherein the organic compound is acetic acid or formic acid, and the ratio of any water present:atomic carbon in the ethanol is from 0:1 to 1.5:1, preferably from 0:1 to 0.5:1.

25. A process according to claim 1 wherein the reaction is continued after the initiation.

26. A process according to claim 25 wherein the reaction is a reforming reaction and produces a product stream comprising carbon dioxide, hydrogen and optionally carbon monoxide or the reaction produces a product stream comprising steam and CO₂ as the main products with at least one of CO, O₂, H₂ and/or CO.

27. A process according to claim 26 wherein any carbon monoxide produced is converted into carbon dioxide by contacting the product stream with a water gas shift catalysts in the presence of water.

28. A process according to claim 1 which is carried out in a fuel cell, to power a rocket, to inflate an air bag, to pressurise mechanical equipment or for the quick start up of a catalytic exhaust gas converter or NOₓ purifier.

29. An apparatus for carrying out a reforming reaction, said apparatus comprising:
storage means containing hydrogen peroxide and an organic compound which is an alcohol, carbohydrate, aldehyde, ketone, carboxylic acid or ether with the proviso that the organic compound is not or does not comprise methanol;
a housing containing at least one group 7, 8, 9, 10 or 11 transition metal catalyst; and
means for introducing the peroxide and organic compound into the housing.

30. An apparatus according to claim 29 wherein the housing contains a platinum-containing catalyst.

31. An apparatus according to claim 29 wherein the housing additionally contains a water gas shift catalyst located downstream of the platinum-containing catalyst.

32. An apparatus according to claim 29 which further comprises a fuel cell downstream of the housing and means for transferring any hydrogen produced in the housing to the fuel cell.
